(19) United States
(12) Patent Application Publication
(10) Pub. No.: US 2025/0148700 A1
(43) Pub. Date: May 8, 2025

(54) INFORMATION PROCESSING APPARATUS CAPABLE OF PREVENTING UNWANTED OBJECTS FROM ENTERING INTO PHOTOGRAPHING RANGE OF VIRTUAL CAMERA IN XR SPACE, CONTROL METHOD FOR INFORMATION PROCESSING APPARATUS, AND STORAGE MEDIUM

(71) Applicant: CANON KABUSHIKI KAISHA, Tokyo (JP)

(72) Inventor: KOTARO OGUMA, Saitama (JP)

(21) Appl. No.: 18/919,936

(22) Filed: Oct. 18, 2024

(30) Foreign Application Priority Data
Nov. 6, 2023 (JP) 2023-189105

(51) Int. Cl. G06T 15/20

(52) U.S. Cl. CPC G06T 15/20; G06T 2200/24; G06T 2210/62

(57) ABSTRACT

An information processing apparatus capable of preventing unwanted objects from entering into a photographing range of a virtual camera in an XR space is provided. The information processing apparatus includes one or more processors and/or circuitry configured to execute a first determination processing that determines whether or not an instruction operation has been performed, execute a first display control processing that, in a case of being determined by the first determination processing that the instruction operation has been performed, superimposes and displays a photographing view angle indicating a photographing range of a virtual camera in an XR space, and execute a fixation processing that fixes objects that are within the photographing view angle of the virtual camera when the photographing view angle of the virtual camera has been displayed as photographing target objects of the virtual camera.

### BACKGROUND OF THE INVENTION

### Cross-Reference to Priority Application

This application claims the benefit of Japanese Patent Application No. 2023-189105, filed on Nov. 6, 2023, which is hereby incorporated by reference herein in its entirety.

### Field of the Invention

The present invention relates to an information processing apparatus, a control method for the information processing apparatus, and a storage medium.

### Description of the Related Art

In recent years, the development of cross reality (XR) has been remarkable. The cross reality is a technology that realizes the fusion of the real world and a virtual world, and is a general term for virtual reality (VR), augmented reality (AR), and mixed reality (MR). The virtual reality is a technology that allows a computer to generate (simulate) an environment in which user(s) are able to interact with virtual object(s). The simulation content includes image(s), voice(s), haptic feedback, and other pseudo sensory information, and provides the user with a perception similar to that of the real space. In the following description, a three-dimensional space (a 3D space) generated by such a simulation will be referred to as “a virtual space”. The user is able to visually recognize the virtual space via a head-mounted type display device or other display device.

The user is able to interact with the virtual object in the virtual space via a motion sensor and/or a controller. In the virtual space, the user is able to communicate with other users through a virtual character called an avatar. In addition, some virtual reality platforms provide a camera function capable of photographing the virtual space with a virtual camera. The camera function allows the user to perform photographing of friend(s) displayed as avatar(s) and scenery in the virtual space by using the virtual camera, just like a camera in the real space, making it possible to preserve memories. In addition, the augmented reality is a simulation technology that displays virtual object(s) superimposed on the real space. In the following description, a three-dimensional space constructed by the augmented reality simulation will be referred to as “an augmented reality space”. Some augmented reality platforms also provide a camera function capable of photographing the augmented reality space with a virtual camera.

In addition, the mixed reality is a simulation technology that further extends the augmented reality, and allows things that are not actually in a certain place to be displayed by overlaying the real world and the virtual world, allowing them to be experienced from any position or angle. In the following description, a three-dimensional space constructed by the mixed reality simulation will be referred to as “a mixed reality space”. Some mixed reality platforms also provide a camera function capable of photographing the mixed reality space with a virtual camera. It should be noted that in the following description, in the case that the virtual space, the augmented reality space, and the mixed reality space are referred to collectively without distinction, they will be referred to as “an XR space”.

Incidentally, when performing photographing with a camera in the real space, it is not possible to clearly understand whether or not a person who is a photographing target (a subject of photographing) is within a photographing range. For this reason, there are many cases where the person who is the photographing target moves into the photographing range according to an instruction from a photographer. In such cases, for example, if a person who is not the photographing target enters into the photographing range without permission, the photographer may unintentionally perform photographing including the person who is not the photographing target, and may not be able to photograph a desired image. In addition, the person who is not the photographing target may be unaware that photographing is being performed and may unintentionally enter into the photographing range, resulting in being photographed without his/her consent.

These events can also occur when performing photographing with a virtual camera in the XR space. In order to deal with this issue, some platforms provide a function for hiding avatars of other users who are located near the user, and/or a function for hiding avatars of other users who are not registered as friends. In addition, Japanese Laid-Open Patent Publication (Kokai) No. 2022-114600 has disclosed a technique that uses parameters of a camera that performs photographing in the real space to display assist information regarding positions and movements for good photographing in an augmented reality space of a pair of AR glasses worn by a wearer.

However, in the technique disclosed in Japanese Laid-Open Patent Publication (kokai) No. 2022-114600, the assist information will not be displayed on a pair of AR glasses worn by the person who is not the photographing target. In addition, with the function for hiding the avatars of the other users who are located near the user, the avatars of the other users may be displayed depending on a distance from the user. Furthermore, with the function for hiding the avatars of the other users who are not registered as friends, the avatars of the other users who have been registered as friends will be displayed regardless of whether they are the photographing target or not. Therefore, even in the case that the above-mentioned technique and functions are applied, there is a risk that an avatar that is not the photographing target may enter into the photographing range of the virtual camera in the XR space.

### SUMMARY OF THE INVENTION

The present invention provides an information processing apparatus capable of preventing unwanted objects from entering into a photographing range of a virtual camera in an XR space, a control method for the information processing apparatus, and a storage medium.

Accordingly, the present invention provides an information processing apparatus comprising one or more processors and/or circuitry configured to execute a first determination processing that determines whether or not an instruction operation has been performed, execute a first display control processing that, in a case of being determined by the first determination processing that the instruction operation has been performed, superimposes and displays a photographing view angle indicating a photographing range of a virtual camera in an XR space, and execute a fixation processing that fixes objects that are within the photographing view angle of the virtual camera when the photographing view angle of the virtual camera has been displayed as photographing target objects of the virtual camera.

According to the present invention, it is possible to prevent the unwanted objects from entering into the photographing range of the virtual camera in the XR space.

Further features of the present invention will become apparent from the following description of exemplary embodiments with reference to the attached drawings.

### BRIEF DESCRIPTION OF THE DRAWINGS

FIGS. 1A, 1B, 1C, and 1D are diagrams for explaining a display control apparatus which is an example of an information processing apparatus according to an embodiment of the present invention.

FIG. 2 is a diagram that shows an example of the external appearance of a controller capable of communicating with the display control apparatus.

FIG. 3 is a flowchart that shows an example of an OS mode processing executed by the display control apparatus.

FIG. 4 is a diagram that shows an example of a screen displayed by the OS mode processing.

FIG. 5 is a flowchart that shows an example of a virtual space application processing executed during the OS mode processing.

FIGS. 6A, 6B, 6C, 6D, 6E, 6F, 6G, and 6H are diagrams that show examples of screens displayed by the virtual space application processing.

FIG. 7 is a flowchart that shows an example of a camera mode processing executed during the virtual space application processing.

FIG. 8 is a flowchart that shows an example of a photographing processing executed during the camera mode processing.

### DESCRIPTION OF THE EMBODIMENTS

The present invention will now be described in detail below with reference to the accompanying drawings showing embodiments thereof.

Hereafter, a preferred embodiment of the present invention will be described in detail with reference to the accompanying drawings. However, the configuration described in the following embodiment is merely an example, and the scope of the present invention is not limited by the configuration described in the following embodiment. For example, each unit (each part) constituting the present invention can be replaced with a unit (a part) having an arbitrary configuration capable of exhibiting a similar function. In addition, arbitrary component(s) may be added. Any two or more configurations (features) of the following embodiment may be combined. Furthermore, the same or similar components are denoted by the same reference numerals in the accompanying drawings, and redundant description will be omitted.

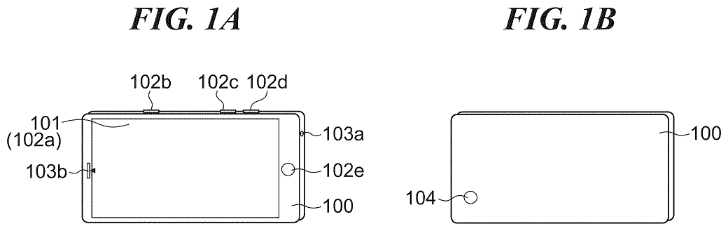

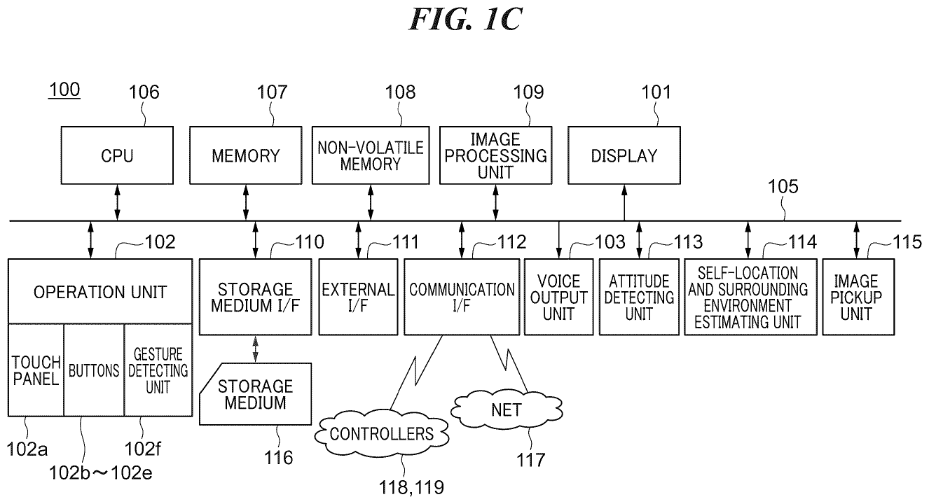

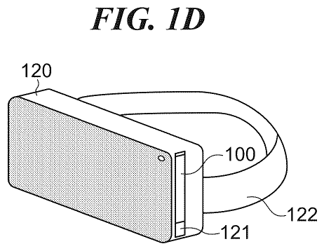

Hereinafter, the preferred embodiment of the present invention will be described with reference to FIGS. 1A to 8. FIG. 1A is a diagram that shows the external appearance of one surface of a display control apparatus 100 which is an example of an information processing apparatus according to the preferred embodiment of the present invention. A display 101 is a display unit that displays images and various kinds of information. As described below, the display 101 is configured integrally with a touch panel 102a, so that a touch operation on a display surface of the display 101 can be detected. The display control apparatus 100 is capable of displaying a VR content or an AR content on the display 101. The touch panel 102a, together with buttons 102b, 102c, 102d, and 102e, etc., constitutes an operation unit 102, which will be described below. The button 102b is a power button that is used when a user switches the power of the display control apparatus 100 on and off.

The button 102c and the button 102d are volume buttons that are used by the user to increase or decrease a volume of a voice (a sound) outputted from a voice output unit 103, which will be described below. The button 102e is a home button that is used by the user to display a home screen on the display 101. A voice output terminal 103a is an earphone jack, and is a terminal for outputting a voice (a sound) to an earphone, an external speaker, or the like. A speaker 103b is a built-in speaker that produces a voice (a sound). FIG. 1B is a diagram that shows the external appearance of the other surface of the display control apparatus 100. A lens 104 is a lens of a camera capable of photographing an image. It should be noted that the image photographed through the lens 104 may be a still image or a moving image (a video image).

FIG. 1C is a block diagram that shows an example of the configuration of the display control apparatus 100. The display control apparatus 100 is able to be configured by using a smartphone or the like. In the display control apparatus 100, a central processing unit (a CPU) 106, a memory 107, a non-volatile memory 108, an image processing unit 109, the display 101, the operation unit 102, a storage medium interface (a storage medium I/F) 110, an external I/F 111, and a communication I/F 112 are connected to an internal bus 105. In the display control apparatus 100, the voice output unit 103, an attitude detecting unit 113, a self-location and surrounding environment estimating unit 114, and an image pickup unit 115 are further connected to the internal bus 105. The respective units (the respective components) connected to the internal bus 105 are capable of exchanging data with one another via the internal bus 105.

The CPU 106 is a control unit that controls the entire display control apparatus 100, and is configured by at least one processor or circuit. The memory 107 is, for example, a random access memory (a RAM) (a volatile memory using a semiconductor element, or the like). The CPU 106 controls the respective units of the display control apparatus 100, for example, according to programs stored in the non-volatile memory 108 and by using the memory 107 as a working memory. The non-volatile memory 108 stores image data, music data, other data, various kinds of programs for the CPU 106 to run, etc. The non-volatile memory 108 is, for example, a flash memory, a read only memory (a ROM), or the like. Under the control of the CPU 106, the image processing unit 109 performs various types of image processing with respect to image data stored or saved in the non-volatile memory 108 or a storage medium 116 described below, image data obtained via the external I/F 111, image data obtained via the communication I/F 112, etc.

The image processing performed by the image processing unit 109 includes an A/D conversion processing, a D/A conversion processing, an image data encoding processing, an image data compression processing, an image data decoding processing, an image data enlargement/reduction processing (resizing), an image data noise reduction processing, an image data color conversion processing, etc. In addition, the image processing unit 109 also performs various types of image processing such as panoramic development of a wide-range image having wide-range data, a mapping processing, and a conversion, regardless of whether the image is an omnidirectional image or not. It should be noted that the image processing unit 109 may be configured with a dedicated circuit block for performing specific image processing. In addition, depending on the type of the image processing, the image processing unit 109 may not be used, and the CPU 106 may carry out the image processing in accordance with a program.

Under the control of the CPU 106, the display 101 displays images, a GUI screen consisting of a graphical user interface (a GUI), etc. The CPU 106 generates display control signals in accordance with the program and controls the respective units of the display control apparatus 100 so that image signals generated for display on the display 101 are outputted to the display 101. In this manner, an image is displayed on the display 101 based on the image signals outputted to the display 101. It should be noted that as one of the components of the display control apparatus 100 itself, the display control apparatus 100 may include an interface for outputting the image signals to be displayed on the display 101, and the display 101 may be configured as an external monitor (such as a television).

The operation unit 102 is an input device for accepting user operations. The operation unit 102 includes the touch panel 102a, the buttons 102b, 102c, 102d, and 102e, and a gesture detecting unit 102f, which will be described below. It should be noted that the operation unit 102 may include a character information input device such as a keyboard, a pointing device such as a mouse, a dial, a joystick, a touch sensor, a touch pad, and the like. The touch panel 102a is a planar input device that is superimposed on the display 101 and outputs coordinate information according to the touched position.

The storage medium I/F 110 allows the storage medium 116 such as a memory card, a compact disc (a CD), or a digital versatile disc (a DVD) to be attached, and reads data from the attached storage medium 116 and writes data to the attached storage medium 116 based on the control of the CPU 106. The external I/F 111 is an interface for inputting and outputting image signals and voice signals (audio signals) by connecting to an external device via a wired cable or wirelessly. The communication I/F 112 is an interface for transmitting and receiving various kinds of data such as files and commands by communicating with external devices via the Internet 117 or the like. Furthermore, the communication I/F 112 is also capable of communicating with wirelessly-connected controllers 118 and 119, which will be described below.

The voice output unit 103 outputs the voice of image (moving image) data, the voice of music data, operation sounds, ringtones, various kinds of notification sounds, and the like. The voice output unit 103 includes the voice output terminal 103a and the speaker 103b. The voice output unit 103 may perform voice output via wireless communication or the like. The attitude detecting unit 113 detects the attitude of the display control apparatus 100 with respect to the direction of gravity, and the inclination of the attitude with respect to each of yaw, roll, and pitch axes. Based on the attitude detected by the attitude detecting unit 113, the CPU 106 is able to determine whether the display control apparatus 100 is being held horizontally, is being held vertically, is facing upward, is facing downward, or is in an oblique attitude.

The attitude detecting unit 113 uses at least one of an acceleration sensor, a gyro sensor, a geomagnetic sensor, an azimuth sensor, an altitude sensor, and the like, but may use a combination of a plurality of sensors. The self-location and surrounding environment estimating unit 114 estimates a self-location and a surrounding environment. The self-location indicates a location in space of the display control apparatus 100 or a head mount adapter 120 described below. The self-location is expressed, for example, by three parameters that represent a position in a coordinate system in which a specific position within a specific range of space is defined as the origin and three mutually perpendicular axes are defined as the X-axis, the Y-axis, and the Z-axis. Furthermore, the self-location may be expressed by adding three parameters that represent the attitude (the orientation).

The surrounding environment is a term that indicates an area in which there are object(s) being obstacle(s) within a range where a user who is carrying the display control apparatus 100 or is wearing the head mount adapter 120 described below is present. The area is expressed by multiple sets of three parameters that represent a position in the coordinate system in which the specific position within the specific range of space is defined as the origin and three mutually perpendicular axes are defined as the X-axis, the Y-axis, and the Z-axis. The image pickup unit 115 is a camera including the lens 104. The images obtained by the image pickup unit 115 are used for various kinds of detection processing that are performed by the self-location and surrounding environment estimating unit 114, the gesture detecting unit 102f described below, and the like. It should be noted that the display 101 is also capable of outputting an image of the outside world.

In addition, as described above, the operation unit 102 includes the touch panel 102a. The CPU 106 is able to detect the following operations or states with respect to the touch panel 102a.

A new touch on the touch panel 102a of a finger or a pen that has not been touching the touch panel 102a, that is, the start of a touch (hereinafter, referred to as “a touch-down”)

A state in which a finger or a pen is touching the touch panel 102a (hereinafter, referred to as “a touch-on”)

A state in which a finger or a pen is moving while touching the touch panel 102a (hereinafter, referred to as “a touch-move”)

A finger or a pen that has been touching the touch panel 102a is removed from the touch panel 102a, that is, the end of a touch (hereinafter, referred to as “a touch-up”)

A state in which nothing is touching the touch panel 102a (hereinafter, referred to as “a touch-off”)

When the touch-down is detected, the touch-on is also detected at the same time. After the touch-down, the touch-on will normally continue to be detected unless the touch-up is detected. In the case that the touch-move has been detected, the touch-on is also detected at the same time. Even in the case that the touch-on has been detected, if the touch position does not move, the touch-move will not be detected. When it is detected that all fingers and/or pens that have been touching the touch panel 102a have been touched up, the touch-off is detected. These operations and states, as well as position coordinates on the touch panel 102a that has been touched by a finger or a pen, are notified to the CPU 106 via the internal bus 105. Based on the notified information, the CPU 106 determines what type of touch operation has been performed on the touch panel 102a.

Regarding the touch-move, the CPU 106 is also able to determine a moving direction of a finger or a pen moving on the touch panel 102a for each vertical component and each horizontal component on the touch panel 102a based on a change in the above-mentioned position coordinates. In the case that the CPU 106 has detected a touch-move of a predetermined distance or more, the CPU 106 determines that a slide operation has been performed. An operation, in which a user touches the touch panel 102a with his/her finger or a pen, moves his/her finger or the pen quickly a certain distance, and then removes his/her finger or the pen from the touch panel 102a, is referred to as a flicking (a flicking operation). In other words, the flicking (the flicking operation) is an operation, in which the user quickly traces the touch panel 102a with his/her finger or the pen in a flicking motion.

When a touch-move is detected over a predetermined distance or more at a predetermined speed or more and then a touch-up is detected, it is determined that a flicking operation has been performed (it is determined that a flicking operation has occurred following a slide operation). Furthermore, a touch operation, in which a user touches a plurality of points (for example, two points) simultaneously and brings the touched positions closer to each other, is referred to as “a pinch-in”. In addition, a touch operation, in which a user touches a plurality of points (for example, two points) simultaneously and moves the touched positions away from each other, is referred to as “a pinch-out”. The pinch-out and the pinch-in are collectively called “a pinching operation (or simply “a pinching”) ”. It should be noted that the CPU 106 is able to detect touch operations that are often used on the smartphone using the touch panel 102a. Such touch operations include the flicking operation and the pinching operation that have been described above, as well as a single tapping operation, a double tapping operation, a long press operation, a swiping operation, etc.

The touch panel 102a may use any one of a variety of types, such as a resistive film type, a capacitive type, a surface acoustic wave type, an infrared type, an electromagnetic induction type, an image recognition type, and an optical sensor type. Furthermore, the touch panel 102a may use a method that detects a touch by contact of a finger or a pen with the touch panel 102a, or a method that detects a touch by approach of a finger or a pen to the touch panel 102a. In addition, the operation unit 102 includes the gesture detecting unit 102f. The CPU 106 is able to obtain a gesture image of the user's hand or the like via the image pickup unit 115 and detect a predetermined gesture by the gesture detecting unit 102f.

FIG. 1D is a diagram that shows the external appearance of the head mount adapter 120 into which the display control apparatus 100 is capable of being inserted. The display control apparatus 100 is also able to be used as a head mounted display by being inserted into the head mount adapter 120. It should be noted that the head mounted display may be of a video see-through type or an optical see-through type. An insertion opening 121 is an insertion opening through which the user inserts the entire display control apparatus 100 into the head mount adapter 120. The display control apparatus 100 is inserted into the insertion opening 121 with the display surface of the display 101 facing the side of a headband 122 (i.e., the user side). The user is able to secure the head mount adapter 120 to his/her head by using the headband 122. Through these efforts, the user is able to view the display 101 of the display control apparatus 100 with the head mount adapter 120 into which the display control apparatus 100 is inserted attached to his/her head, that is, the user is able to view the display 101 of the display control apparatus 100 in a state in which the user does not hold the display control apparatus 100.

In this case, when the user moves his/her head or entire body, the attitude of the display control apparatus 100 also changes. The attitude detecting unit 113 detects a change in the attitude of the display control apparatus 100 at this time. The CPU 106 performs a VR display processing or an AR display processing based on the result of this detection. In this case, the detection of the attitude of the display control apparatus 100 by the attitude detecting unit 113 is equivalent to detecting the attitude of the user's head (i.e., the direction in which the user's line of sight is facing). It should be noted that in the display control apparatus 100, the user's line of sight, the user's facial expression, and the like may be detected, and the detection information may be used as an operation event.

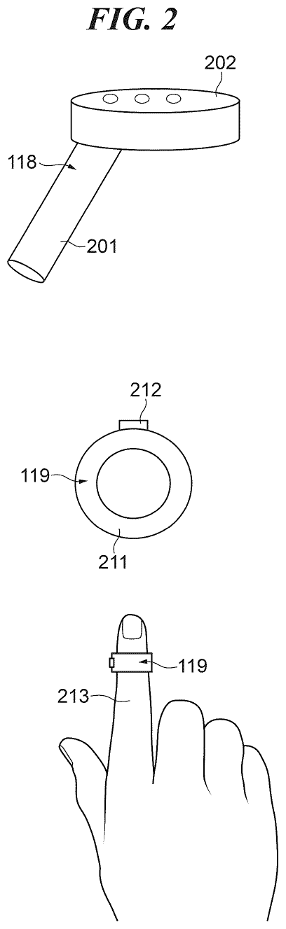

FIG. 2 is a diagram that shows an example of the external appearance of the controllers 118 and 119 that are capable of communicating with the display control apparatus 100. The grip-type controller 118 includes a holding portion 201 and an operation surface 202. In the grip-type controller 118, the user holds the holding portion 201 with his/her hand and operates the member of the operation surface 202. As a result, an operation event is notified from the grip-type controller 118 to the display control apparatus 100. It should be noted that the grip-type controller 118 may be used by the user holding one in each hand.

In addition, the ring-type controller 119 includes a ring portion 211 and a ring operation portion 212. The ring portion 211 is worn on a finger 213 of the user. The ring operation portion 212 may be a member such as a push button, a member such as a rotary dial, or a member capable of detecting finger contact, such as an optical trackpad. The ring operation portion 212 notifies the display control apparatus 100 of an operation event when operated by the user. In the following, a case will be described in which the user wears the head mount adapter 120 into which the display control apparatus 100 is inserted and uses the controller 118, but the same applies when the user uses the controller 119.

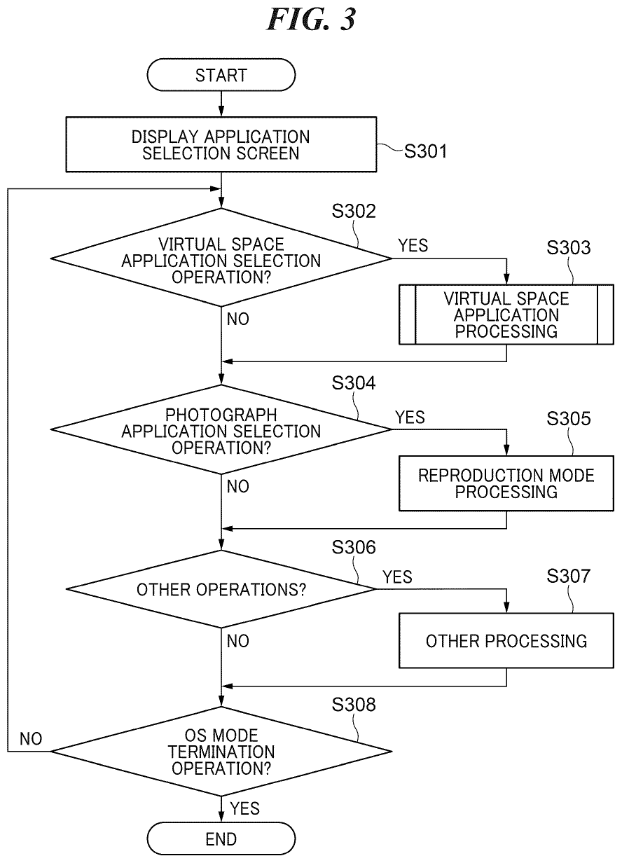

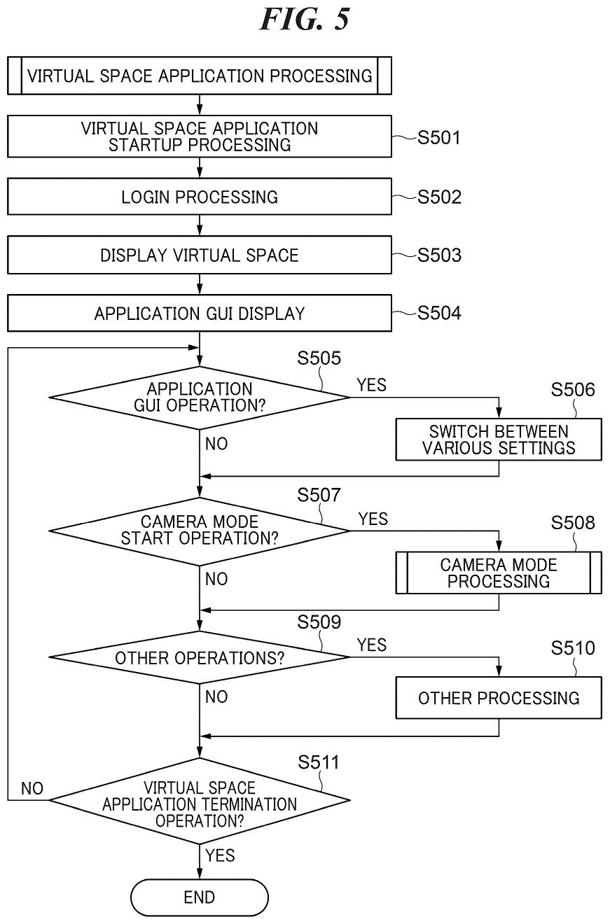

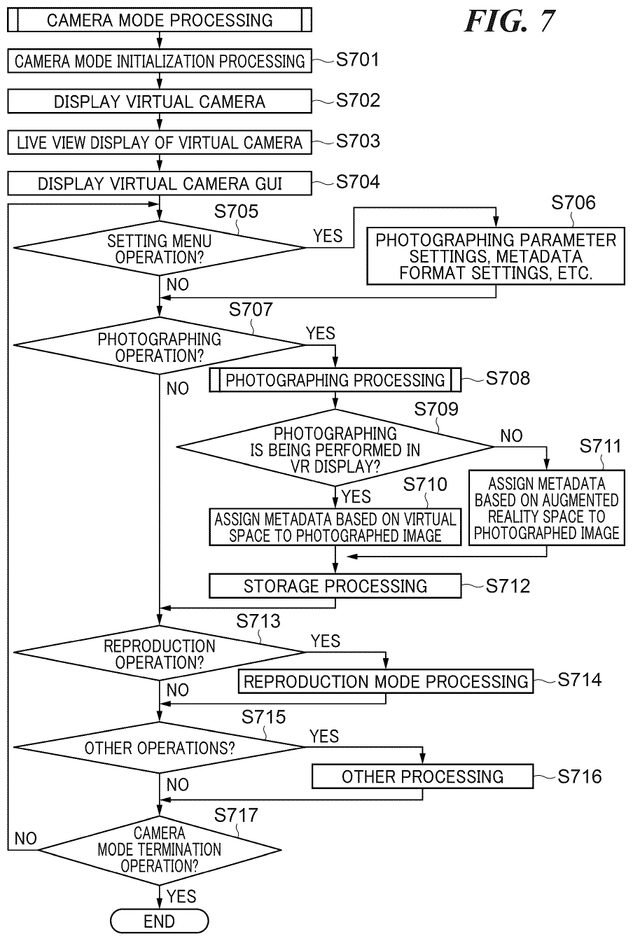

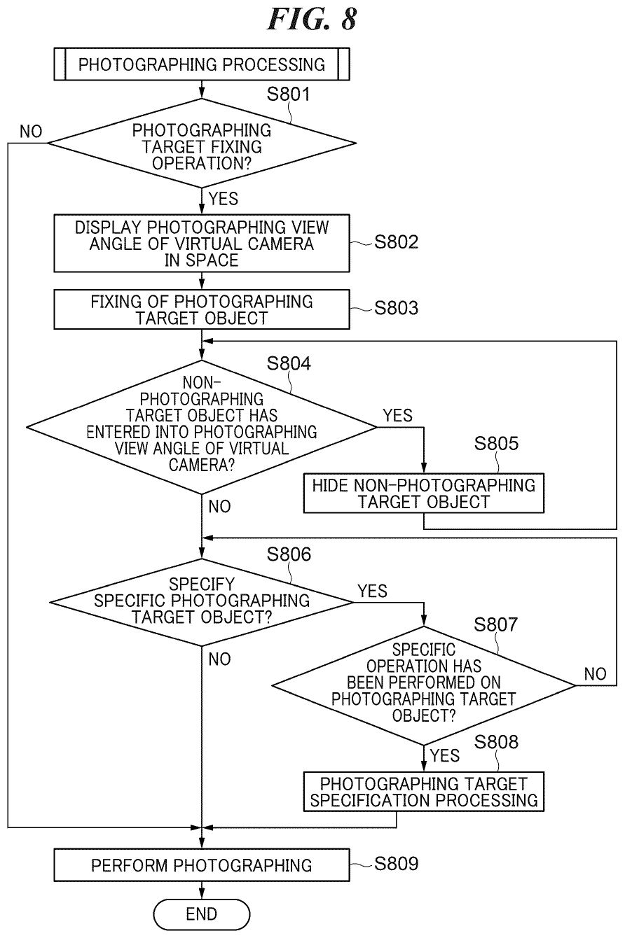

FIG. 3 is a flowchart that shows an example of an OS mode processing executed by the display control apparatus 100. In the case that it has been detected that the display control apparatus 100 has been inserted into the head mount adapter 120, or in the case that the user has performed a start operation with the controller 118, the display control apparatus 100 starts the OS mode processing shown in FIG. 3. The OS mode processing shown in FIG. 3 (a control method for the information processing apparatus) is realized by the CPU 106 (a computer) loading the program stored in the non-volatile memory 108 into the memory 107 and executing it. It should be noted that this also applies to a processing shown in a flowchart of FIG. 5, a processing shown in a flowchart of FIG. 7, and a processing shown in a flowchart of FIG. 8 that will be described below. When the OS mode processing shown in FIG. 3 is started, first, in a step S301, the CPU 106 displays on the display 101 a screen for the user to select an application included in the display control apparatus 100.

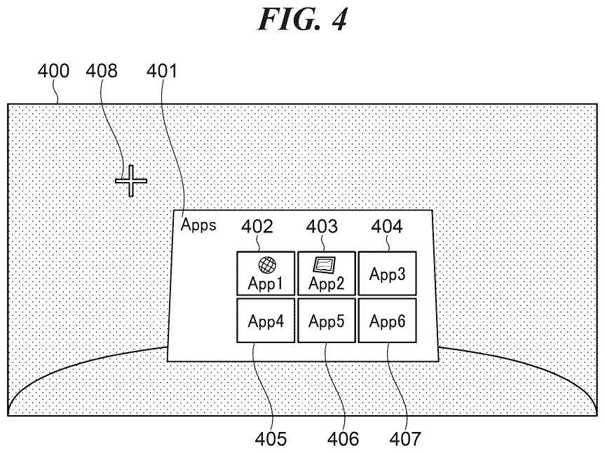

FIG. 4 is a diagram that shows an example of the screen displayed by the OS mode processing, for selecting an application included in the display control apparatus 100. In the screen shown in FIG. 4, an application selection screen 401 is superimposed and displayed on a virtual space 400. Icons 402 to 407 representing various kinds of applications are displayed on the application selection screen 401. When the user performs an operation to select one of the icons 402 to 407, an application corresponding to the selected icon is started. In the following, a case will be described in which a virtual space application is started by selecting the icon 402 and a photograph application is started by selecting the icon 403. It should be noted that the photograph application is an application that reproduces (plays back) images that have been stored in the display control apparatus 100. In addition, there may be a plurality of virtual space applications.

Even in the case that the user is wearing the head mount adapter 120 into which the display control apparatus 100 is inserted, the user is able to use the controller 118 to perform operations such as selecting and moving GUI objects displayed on the display 101. Furthermore, the user is able to move a pointer 408 to any position by operating the controller 118. The user is able to operate the member of the controller 118 while making the pointer 408 become close to (or overlapped with) any icon, thereby selecting that icon. It should be noted that these points also apply in the case that the user uses the controller 119. In addition, the user is also able to move the pointer 408 to any position by using the above-mentioned attitude detecting unit 113, that is, depending on the user's attitude and the direction of the user's line of sight.

Returning to the description of FIG. 3. In a step S302, the CPU 106 determines whether or not a selection operation for the virtual space application (a virtual space application selection operation) has been performed. In the case that a selection operation for the icon 402 has been performed, the CPU 106 determines that a virtual space application selection operation has been performed. In this case, the OS mode processing shown in FIG. 3 proceeds to a step S303. On the other hand, in the case that a selection operation for the icon 402 has not been performed, the CPU 106 determines that a virtual space application selection operation has not been performed. In this case, the OS mode processing shown in FIG. 3 proceeds to a step S304. In the step S303, the CPU 106 executes a virtual space application processing, which will be described below.

In the step S304, the CPU 106 determines whether or not a selection operation for the photograph application (a photograph application selection operation) has been performed. In the case that a selection operation for the icon 403 has been performed, the CPU 106 determines that a photograph application selection operation has been performed. In this case, the OS mode processing shown in FIG. 3 proceeds to a step S305. On the other hand, in the case that a selection operation for the icon 403 has not been performed, the CPU 106 determines that a photograph application selection operation has not been performed. In this case, the OS mode processing shown in FIG. 3 proceeds to a step S306. In the step S305, the CPU 106 executes a reproduction mode processing. In the reproduction mode processing, the CPU 106 performs image reproduction with respect to all images that have been stored in the storage medium 116 of the display control apparatus 100.

In the step S306, the CPU 106 determines whether or not other operations have been performed. This determination is made based on a user operation on the controller 118, etc. It should be noted that the other operations include, for example, a pairing operation with another display control apparatus (for example, a smartphone) and an operation related to settings for automatic transfer of photographed images to the paired smartphone. In the case that the CPU 106 determines that the other operations have been performed, the OS mode processing shown in FIG. 3 proceeds to a step S307. On the other hand, in the case that the CPU 106 determines that the other operations have not been performed, the OS mode processing shown in FIG. 3 proceeds to a step S308. In the step S307, the CPU 106 performs other processing based on the other operations or the like, which have been determined in the step S306. In the step S308, the CPU 106 determines whether or not an OS mode termination operation has been performed. This determination is made based on a user operation on the controller 118, etc. In the case that the CPU 106 determines that an OS mode termination operation has not been performed, the OS mode processing shown in FIG. 3 returns to the step S302. On the other hand, in the case that the CPU 106 determines that an OS mode termination operation has been performed, the OS mode processing shown in FIG. 3 ends.

FIG. 5 is the flowchart that shows an example of the virtual space application processing executed in the step S303. When the virtual space application processing shown in FIG. 5 is started, first, in a step S501, the CPU 106 performs a processing of starting up the virtual space application (a virtual space application startup processing). The virtual space application startup processing is realized by the CPU 106 loading the program stored in the non-volatile memory 108 into the memory 107 and executing it. Furthermore, the CPU 106 performs initialization of flags, control variables, and the like in order to execute the virtual space application. In a step S502, the CPU 106 executes a login processing based on the user's account information. Through the login processing, the CPU 106 loads the user's avatar, the user's attribute information, and the like from a server that provides a service of the virtual space application.

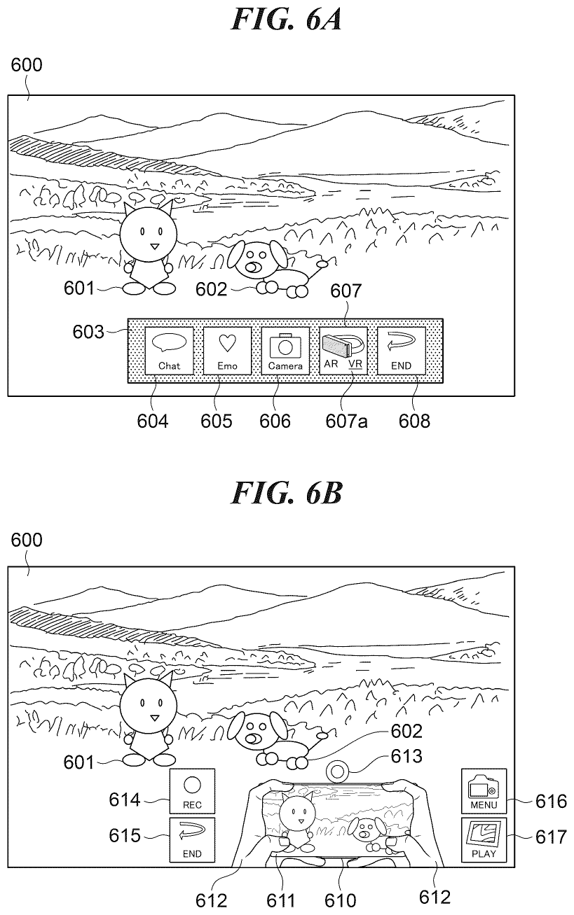

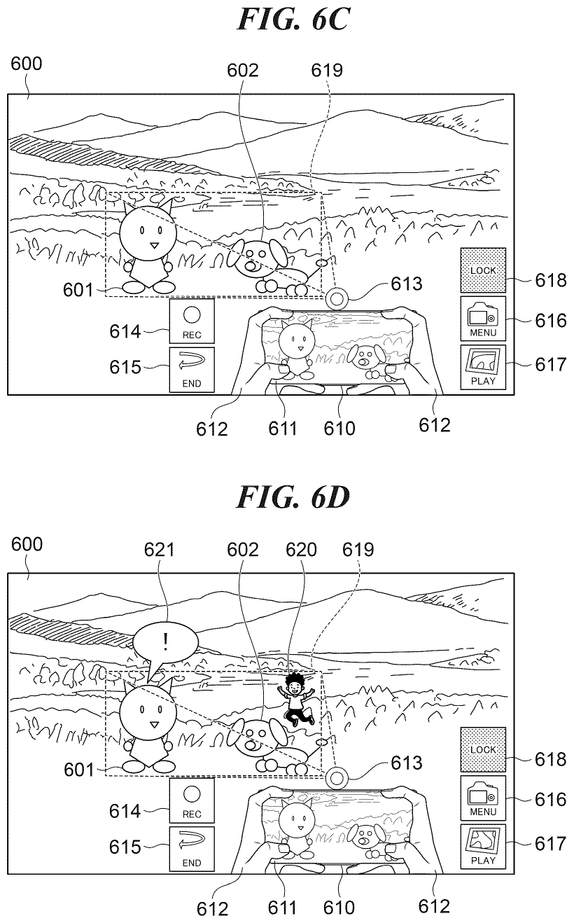

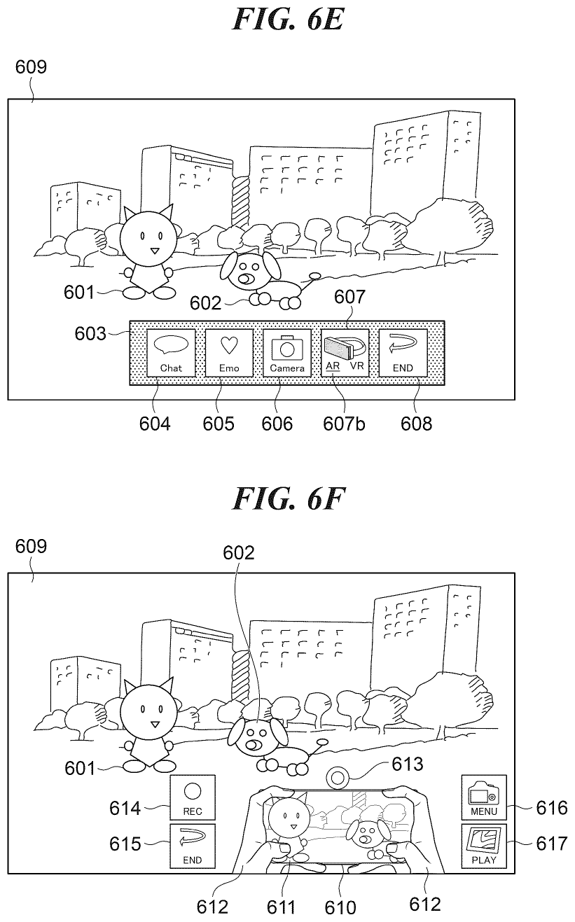

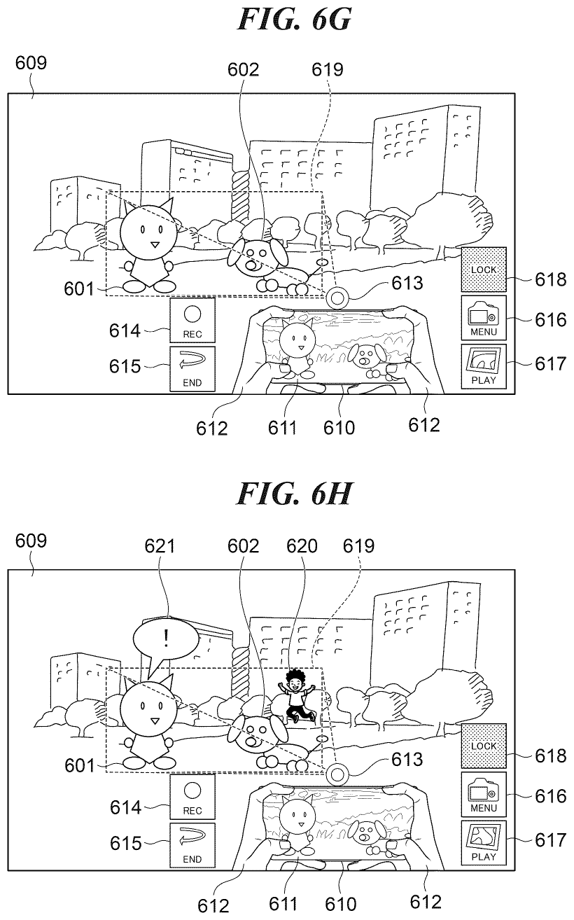

In a step S503, the CPU 106 displays a virtual space, etc. on the display 101. FIGS. 6A, 6B, 6C, 6D, 6E, 6F, 6G, and 6H are diagrams that show examples of screens displayed by the virtual space application. FIG. 6A is a diagram that shows an example of a screen in a virtual space display. On the screen shown in FIG. 6A, a virtual space 600, a virtual person 601, and a virtual animal 602 are displayed. The virtual person 601 and the virtual animal 602 may be avatars of other users who share the virtual space 600 with the user by logging in to the virtual space 600, or the control of the behaviors of the virtual person 601 and the virtual animal 602 such as the movements of their positions may be performed by the server that provides the service of the virtual space application. It should be noted that each of the screens shown in FIGS. 6A, 6B, 6C, 6D, 6E, 6F, 6G, and 6H is a first-person perspective screen in which the avatar of the user wearing the head mount adapter 120 is not displayed, but it may be a third-person perspective screen in which the avatar of the user wearing the head mount adapter 120 is displayed.

Returning to the description of FIG. 5. In a step S504, the CPU 106 performs a GUI display for performing various kinds of operations in the virtual space application. In FIG. 6A, a virtual space application GUI 603 is an example of such a GUI display. On the screen shown in FIG. 6A, the virtual space application GUI 603 is superimposed and displayed on the virtual space 600. Icons 604 to 608 indicating various kinds of functions are displayed side by side on the virtual space application GUI 603. The function indicated by the icon 604 is a chat function that enables communication with other users.

The function indicated by the icon 605 is an emotion function that allows emotions to be expressed. The function indicated by the icon 606 is a camera function that allows performing photographing in the virtual space 600 by using a virtual camera. The function indicated by the icon 607 is a space display switching function that switches between the virtual space display and an augmented reality space display. The function indicated by the icon 608 is an end function that ends the virtual space application. It should be noted that the icon 607 for the space display switching function displays information about which space display is currently being used. Since the virtual space 600 is displayed on the screen shown in FIG. 6A, information 607a indicating the virtual space display is displayed on the icon 607 for the space display switching function.

In addition, FIG. 6E is a diagram that shows an example of a screen in the augmented reality space display. On the screen shown in FIG. 6E, an augmented reality space 609 is displayed as a background image. Furthermore, on the screen shown in FIG. 6E, the virtual person 601, the virtual animal 602, and the virtual space application GUI 603 that have been described above are superimposed and displayed on the augmented reality space 609. Since the augmented reality space 609 is displayed on the screen shown in FIG. 6E, information 607b indicating the augmented reality space display is displayed on the icon 607 for the space display switching function.

Returning to the description of FIG. 5. In a step S505, the CPU 106 determines whether or not an operation has been performed with respect to the virtual space application GUI 603 (excluding the icon 606 and the icon 608). In the case that the CPU 106 determines that an operation has been performed with respect to the virtual space application GUI 603, the virtual space application processing shown in FIG. 5 proceeds to a step S506. On the other hand, in the case that the CPU 106 determines that an operation has not been performed with respect to the virtual space application GUI 603, the virtual space application processing shown in FIG. 5 proceeds to a step S507. In the step S506, the CPU 106 performs a processing such as switching between various settings based on the operation determined in the step S505. For example, in the case that a selection operation for the icon 604 has been performed, the CPU 106 performs a processing of communicating with other users, and in the case that a selection operation for the icon 607 has been performed, the CPU 106 performs a processing of switching between the virtual space display and the augmented reality space display.

In the step S507, the CPU 106 determines whether or not a camera mode start operation has been performed. In the case that a selection operation for the icon 606 has been performed, the CPU 106 determines that a camera mode start operation has been performed. In this case, the virtual space application processing shown in FIG. 5 proceeds to a step S508. On the other hand, in the case that a selection operation for the icon 606 has not been performed, the CPU 106 determines that a camera mode start operation has not been performed. In this case, the virtual space application processing shown in FIG. 5 proceeds to a step S509. In the step S508, the CPU 106 executes a camera mode processing, which will be described below. In the step S509, the CPU 106 determines whether or not other operations or the like have been performed. This determination is made based on a user operation on the controller 118, etc. In the case that the CPU 106 determines that the other operations or the like have been performed, the virtual space application processing shown in FIG. 5 proceeds to a step S510. On the other hand, in the case that the CPU 106 determines that the other operations or the like have not been performed, the virtual space application processing shown in FIG. 5 proceeds to a step S511.

In the step S510, the CPU 106 performs other processing based on the other operations or the like, which have been determined in the step S509. The other processing include, for example, a processing of switching a display range of the virtual space 600 displayed on the display 101 when the user's viewpoint moves due to a change in the attitude of the head mount adapter 120 or the like. In the step S511, the CPU 106 determines whether or not a virtual space application termination operation has been performed. In the case that a selection operation for the icon 608 has not been performed, the CPU 106 determines that a virtual space application termination operation has not been performed. In this case, the virtual space application processing shown in FIG. 5 returns to the step S505. On the other hand, in the case that a selection operation for the icon 608 has been performed, the CPU 106 determines that a virtual space application termination operation has been performed. In this case, the virtual space application processing shown in FIG. 5 ends, and the processing returns to the OS mode processing shown in FIG. 3.

FIG. 7 is the flowchart that shows an example of the camera mode processing executed in the step S508. When the camera mode processing shown in FIG. 7 is started, first, in a step S701, the CPU 106 executes an initialization processing for the camera mode (a camera mode initialization processing). In the camera mode initialization processing, various kinds of parameters that have been set by the user the last time the user has used the camera mode are called up. In a step S702, the CPU 106 displays a virtual camera 610, which will be described below. In a step S703, the CPU 106 displays a live view 611, which will be described below and is superimposed on the virtual camera 610. In a step S704, the CPU 106 displays a virtual camera GUI, which will be described below.

FIG. 6B is a diagram that shows an example of a screen in the camera mode in the virtual space display. On the screen shown in FIG. 6B, the virtual space 600 is displayed as a background image. Furthermore, on the screen shown in FIG. 6B, in addition to the virtual person 601 and the virtual animal 602 that have been described above, the virtual camera 610, the live view 611, virtual hands 612 of the user, a virtual lens 613, and icons 614 to 617 are superimposed and displayed on the virtual space 600. The live view 611 of the virtual camera 610 is superimposed and displayed on the virtual camera 610. In addition, the virtual camera 610 is shown being held in the virtual hands 612 of the user. Furthermore, the virtual lens 613 and the icons 614 to 617 indicating various kinds of functions are displayed around the virtual camera 610. Here, the icons 614 to 617 correspond to the above-mentioned virtual camera GUI.

The virtual camera GUI is configured with the icon 614 for a photographing start button, the icon 615 for a camera mode end button, the icon 616 for displaying a setting menu screen, and the icon 617 for starting a reproduction mode, but is not limited to this configuration. In addition, FIG. 6F is a diagram that shows an example of a screen in the camera mode in the augmented reality space display. On the screen shown in FIG. 6F, the augmented reality space 609 is displayed as a background image. Furthermore, on the screen shown in FIG. 6F, the virtual person 601, the virtual animal 602, the virtual camera 610, the live view 611, the virtual hands 612 of the user, the virtual lens 613, and the icons 614 to 617 that have been described above are superimposed and displayed on the augmented reality space 609. It should be noted that in the virtual space 600 or the augmented reality space 609, the user is able to use the virtual hands 612 or the like to perform touch operations that are often used on the smartphone in the real space. In other words, the user is able to perform operations such as a single tapping operation, a double tapping operation, a long press operation, a flicking operation, a swiping operation, and a pinching operation in the virtual space 600 or the augmented reality space 609 by using the virtual hands 612 or the like.

Returning to the description of FIG. 7. In a step S705, the CPU 106 determines whether or not a setting menu operation has been performed. In the case that a selection operation for the icon 616 has been performed, the CPU 106 determines that a setting menu operation has been performed. In this case, the camera mode processing shown in FIG. 7 proceeds to a step S706. On the other hand, in the case that a selection operation for the icon 616 has not been performed, the CPU 106 determines that a setting menu operation has not been performed. In this case, the camera mode processing shown in FIG. 7 proceeds to a step S707. In the step S706, the CPU 106 displays a setting menu (not shown).

The setting menu (not shown) allows the user to switch settings for the virtual camera 610 such as a format of an image to be photographed, photographing parameters, and a format of metadata to be added to a photographed image. The image photographed by the virtual camera 610 may be a still image or a moving image (a video image). Furthermore, the format of the photographed image may be a normal image (a 2D image), or a 360° or VR180 image. The photographing parameters may be a shutter speed, an aperture, an ISO sensitivity, an exposure compensation, etc. In addition, settings for image processing such as background blurring and skin beautifying effects may be switched. It should be noted that the format of the metadata to be added to the photographed image will be described below together with the description of steps S710 and S711.

In the step S707, the CPU 106 determines whether or not a photographing operation has been performed. In the case that a selection operation for the icon 614 has been performed, the CPU 106 determines that a photographing operation has been performed. In this case, the camera mode processing shown in FIG. 7 proceeds to a step S708. On the other hand, in the case that a selection operation for the icon 614 has not been performed, the CPU 106 determines that a photographing operation has not been performed. In this case, the camera mode processing shown in FIG. 7 proceeds to a step S713. In the step S708, the CPU 106 performs a photographing processing. In the photographing processing, in the case of performing photographing of a 2D image, the CPU 106 performs the photographing processing of the image based on the image currently displayed on the live view 611 of the virtual camera 610. Furthermore, in the case of performing photographing of a 360° image, the CPU 106 photographs the surrounding space visible from the virtual camera 610 as an image. It should be noted that the photographing processing will be described in detail below.

In a step S709, the CPU 106 determines whether or not photographing is being performed in the virtual space display (the VR display). In the case that the CPU 106 determines that photographing is being performed in the virtual space display, the camera mode processing shown in FIG. 7 proceeds to the step S710. On the other hand, in the case that the CPU 106 determines that photographing is not being performed in the virtual space display, that is, in the case that the CPU 106 determines that photographing is being performed in the augmented reality space display (the AR display), the camera mode processing shown in FIG. 7 proceeds to the step S711. In the step S710, the CPU 106 adds (assigns) metadata based on the virtual space to the photographed image. In the step S711, the CPU 106 adds (assigns) metadata based on the augmented reality space to the photographed image.

The metadata added here may be in any format as long as it includes information that allows a virtual image to be identified from a non-virtual image. The CPU 106 may simply add binary flag information, which is capable of identifying a virtual image from a non-virtual image, to the photographed image, or may add spatial information about the virtual space and a non-virtual space (for example, position information within the space) and time information to the photographed image. In addition, the metadata may be in exchangeable image file format (Exif). In the case of the Exif format, the CPU 106 may add parameters such as the shutter speed at the time of photographing, in addition to the position information, to the photographed image based on the Exif specifications.

In a step S712, the CPU 106 executes a storage processing. In the storage processing, the CPU 106 stores photographed images photographed by the virtual camera 610 in the storage medium 116. At this time, the CPU 106 stores the photographed images in an area of the storage medium 116 that is dedicated to the virtual space application. Furthermore, the CPU 106 may store the photographed images in an area of the storage medium 116 that is capable of performing reproduction by the reproduction mode processing in the OS mode processing. In addition, the CPU 106 may directly store the photographed images photographed by the virtual camera 610 in an external device or an external server. In the step S713, the CPU 106 determines whether or not a reproduction operation has been performed. In the case that a selection operation for the icon 617 has been performed, the CPU 106 determines that a reproduction operation has been performed. In this case, the camera mode processing shown in FIG. 7 proceeds to a step S714. On the other hand, in the case that a selection operation for the icon 617 has not been performed, the CPU 106 determines that a reproduction operation has not been performed. In this case, the camera mode processing shown in FIG. 7 proceeds to a step S715.

In the step S714, the CPU 106 executes a reproduction mode processing. In the reproduction mode processing, the CPU 106 performs reproduction with respect to images that have been stored in the area dedicated to the virtual space application, among the images that have been stored in the storage medium 116 of the display control apparatus 100. In the step S715, the CPU 106 determines whether or not other operations have been performed. This determination is made based on a user operation on the controller 118, etc. In the case that the CPU 106 determines that the other operations have been performed, the camera mode processing shown in FIG. 7 proceeds to a step S716. On the other hand, in the case that the CPU 106 determines that the other operations have not been performed, the camera mode processing shown in FIG. 7 proceeds to a step S717.

In the step S716, the CPU 106 performs other processing based on the other operations or the like, which have been determined in the step S715. In this processing, the CPU 106 changes a display range of the live view 611 of the virtual camera 610 in response to, for example, a user operation on the controller 118 and/or a change in the attitude of the head mount adapter 120. In the step S717, the CPU 106 determines whether or not a camera mode termination operation has been performed. In the case that a selection operation for the icon 615 has not been performed, the CPU 106 determines that a camera mode termination operation has not been performed. In this case, the camera mode processing shown in FIG. 7 returns to the step S705. On the other hand, in the case that a selection operation for the icon 615 has been performed, the CPU 106 determines that a camera mode termination operation has been performed. In this case, the camera mode processing shown in FIG. 7 ends, and the processing returns to the virtual space application processing shown in FIG. 5.

FIG. 8 is the flowchart that shows an example of the photographing processing executed in the step S708. When the photographing processing shown in FIG. 8 is started, first, in a step S801, the CPU 106 (a first determining unit) determines whether or not an operation to fix a photographing target (a photographing target fixing operation) (an instruction operation) has been performed (a determination step). In the case that a selection operation for a photographing target fixing icon 618, which will be described below, has been performed, the CPU 106 determines that a photographing target fixing operation has been performed. In this case, the photographing processing shown in FIG. 8 proceeds to a step S802. On the other hand, in the case that a selection operation for the photographing target fixing icon 618 has not been performed, the CPU 106 determines that a photographing target fixing operation has not been performed. In this case, the photographing processing shown in FIG. 8 proceeds to a step S809. It should be noted that although the photographing target fixing icon 618 is an icon dedicated to the photographing target fixing operation, it may be an existing icon to which a function for the photographing target fixing operation has been added.

In the step S802, the CPU 106 (a first display control unit) superimposes and displays a radial photographing view angle (a radial photographing angle of view) 619, which will be described below, in the virtual space 600 or the augmented reality space 609 (a display control step). As a result, also on display control apparatuses of other users who have logged in to the virtual space 600 or the augmented reality space 609, the radial photographing view angle 619 is superimposed and displayed on the virtual space 600 or the augmented reality space 609. Furthermore, the CPU 106 transparently displays the photographing view angle 619. By transparently displaying the photographing view angle 619, in the virtual space 600 or the augmented reality space 609, the background within the photographing view angle 619 becomes visible. It should be noted that the step S802 may be performed by the server that provides the service of the virtual space application.

In a step S803, the CPU 106 (a fixing unit) performs fixing of photographing target object(s). Specifically, the CPU 106 fixes objects within the photographing view angle 619 of the virtual camera 610 in the virtual space 600 or the augmented reality space 609, that is, the virtual person 601 and the virtual animal 602, as the photographing target objects of the virtual camera 610. As a result, the user is able to intentionally fix the photographing target objects of the virtual camera 610. Furthermore, a tracking function of the virtual camera 610 becomes possible. In addition, even in the case that an object intentionally (for example, for prank purposes) or accidentally (for example, passing by) enters into the photographing view angle 619 of the virtual camera 610, it will not be fixed as the photographing target objects of the virtual camera 610. It should be noted that in the case that an object other than the user's intention (an object different from the user's intention) has been fixed as the photographing target object, the user performs a predetermined operation such as an operation of flicking the object with the virtual hands 612 or an operation of swiping the object with the virtual hands 612 on the live view 611 of the virtual camera 610. The CPU 106 (an excluding unit) excludes, from the photographing target objects, an object that has become the target of the flicking operation or the swiping operation performed by the user. It should be noted that the predetermined operation may be a touch operation other than a flicking operation and a swiping operation.

In a step S804, the CPU 106 determines whether or not a non-photographing target object has entered into the photographing view angle 619. In the case that the CPU 106 determines that a non-photographing target object has entered into the photographing view angle 619, the photographing processing shown in FIG. 8 proceeds to a step S805. On the other hand, in the case that the CPU 106 determines that a non-photographing target object has not entered into the photographing view angle 619, the photographing processing shown in FIG. 8 proceeds to a step S806. In the step S805, the CPU 106 (a non-display unit) hides the non-photographing target object on the live view 611 of the virtual camera 610. This prevents the virtual camera 610 from photographing the non-photographing target object. In addition, since the non-photographing target object is hidden before photographing, it is possible to avoid a distortion that occurs when deleting the non-photographing target object from the photographed image. It should be noted that after the step S805, the photographing processing shown in FIG. 8 returns to the step S804.

In the step S806, the CPU 106 determines whether or not to specify (clearly indicate) a specific photographing target object. This determination is made based on a user operation on the controller 118, etc. In the case that the CPU 106 determines to specify a specific photographing target object, the photographing processing shown in FIG. 8 proceeds to a step S807. On the other hand, in the case that the CPU 106 determines not to specify a specific photographing target object, the photographing processing shown in FIG. 8 proceeds to the step S809. In the step S807, the CPU 106 (a second determining unit) determines whether or not the user has performed a specific operation (a specifying operation) with respect to the photographing target object.

It should be noted that the specific operation may be an operation in which the user single-taps the photographing target object with the virtual hands 612 on the live view 611 of the virtual camera 610, an operation in which the user double-taps the photographing target object with the virtual hands 612 on the live view 611 of the virtual camera 610, or an operation in which the user long-presses the photographing target object with the virtual hands 612 on the live view 611 of the virtual camera 610. In addition, the specific operation may be performed with respect to at least one of the photographing target objects. It should be noted that the specific operation may be a touch operation other than a single tapping operation, a double tapping operation, and a long press operation. In the case that the CPU 106 determines that the user has performed a specific operation with respect to the photographing target object, the photographing processing shown in FIG. 8 proceeds to a step S808. On the other hand, in the case that the CPU 106 determines that the user has not performed a specific operation with respect to the photographing target object, the photographing processing shown in FIG. 8 returns to the step S806.

In the step S808, the CPU 106 (a second display control unit) executes a photographing target specification processing. In the photographing target specification processing, the CPU 106 displays a specific icon around the photographing target object that has become the target of the specific operation performed by the user, among the photographing target objects of the virtual camera 610, in the virtual space 600 or the augmented reality space 609. It should be noted that the CPU 106 may display the photographing target object that has become the target of the specific operation performed by the user in a blinking manner or with an illuminated border instead of displaying a specific icon. In this manner, the CPU 106 is able to specify and display (clearly indicate and display) the photographing target object desired by the user, among the photographing target objects of the virtual camera 610. In addition, other users are able to recognize the photographing target object of the virtual camera 610 by the display of a specific icon, or the like. It should be noted that the CPU 106 may specify and display (clearly indicate and display) all of the photographing target objects of the virtual camera 610. In the step S809, the CPU 106 (a photographing unit) performs photographing by using the virtual camera 610. Thereafter, the photographing processing shown in FIG. 8 ends, and the processing returns to the virtual space application processing shown in FIG. 5.

FIG. 6C and FIG. 6D are diagrams that show examples of the screen transition in the camera mode in the virtual space display. FIG. 6C is a diagram that shows an example of a screen when fixing the photographing target. On the screen shown in FIG. 6C, the virtual camera 610 is superimposed and displayed on the virtual space 600. The live view 611 is superimposed and displayed on the virtual camera 610. As image information entering through the virtual lens 613, the virtual space 600, the virtual person 601, and the virtual animal 602 are displayed on the live view 611 of the virtual camera 610. On the screen shown in FIG. 6C, the photographing target fixing icon 618 is superimposed and displayed on the virtual space 600. When a selection operation for the photographing target fixing icon 618 is performed by the user, the photographing view angle 619 indicating a photographing range of the virtual camera 610 is displayed (the step S802). At that time, the shape of the photographing view angle 619 of the virtual camera 610 is a radial shape spreading out from the virtual lens 613. In addition, since the photographing view angle 619 of the virtual camera 610 is displayed transparently, the virtual person 601 and the virtual animal 602 that are within the photographing view angle 619 of the virtual camera 610, as well as the background within the photographing view angle 619 of the virtual camera 610, become visible.

At the same time, the virtual person 601 and the virtual animal 602 that are within the photographing view angle 619 of the virtual camera 610 are fixed as the photographing target objects (the step S803). FIG. 6D is a diagram that shows an example of an image when a non-photographing target object 620 has entered into the photographing view angle 619 of the virtual camera 610 when fixing the photographing target. When fixing of the photographing target object is performed, even in the case that the non-photographing target object 620 has entered into the photographing view angle 619 of the virtual camera 610, the non-photographing target object 620 will not be displayed on the live view 611 of the virtual camera 610 (the step S805).

In addition, a specific icon 621 is displayed above the head of the virtual person 601, who is the photographing target object, by the photographing target specification processing performed in the step S808. It should be noted that the location where the specific icon 621 is displayed is not limited to above the head of the virtual person 601, who is the photographing target object, but may be anywhere around the virtual person 601, who is the photographing target object (for example, next to the face). FIG. 6G and FIG. 6H are diagrams that show examples of the screen transition in the camera mode in the augmented reality space display. The description of FIG. 6G and FIG. 6H is omitted since it is similar to the description of FIG. 6C and FIG. 6D described above.

As described above, in the display control apparatus 100, when a selection operation for the icon 618 is performed by the user, the photographing view angle 619 indicating the photographing range of the virtual camera 610 is superimposed and displayed on the virtual space 600 or the augmented reality space 609. As a result, in the display control apparatus 100, since other users become able to view the photographing view angle 619 of the virtual camera 610 in the virtual space 600 or the augmented reality space 609, it is possible to prevent unwanted objects from entering into the photographing range of the virtual camera 610. Furthermore, it becomes possible to be considerate of other users who do not want to be photographed.

Although the preferred embodiment of the present invention has been described above, the present invention is not limited to the above-described embodiment, and various modifications and changes are possible within the scope of the gist of the present invention. For example, the CPU 106 (a notifying unit) may notify another user of the non-photographing target object 620 that has entered into the photographing view angle 619, that the non-photographing target object 620 has entered into the photographing view angle 619. In addition, the display control apparatus 100 may perform an MR display processing that displays a mixed reality space (the XR space). The display control apparatus 100 is not limited to a smartphone, but may be, for example, smart glasses, a tablet terminal, a digital camera, or the like. It should be noted that in the case of a digital camera, for example, a function such as an operation of fixing the photographing target may be added to an existing button such as a release button or an AF lock button, and the existing button may be used as the photographing target fixing icon 618 or the like.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An information processing apparatus comprising one or more processors and/or circuitry configured:
to execute a first determination processing that determines whether or not an instruction operation has been performed;
to execute a first display control processing that, in a case of being determined by the first determination processing that the instruction operation has been performed, superimposes and displays a photographing view angle indicating a photographing range of a virtual camera in an XR space; and
to execute a fixation processing that fixes objects that are within the photographing view angle of the virtual camera when the photographing view angle of the virtual camera has been displayed as photographing target objects of the virtual camera.

2. The information processing apparatus according to claim 1, wherein the instruction operation is an operation performed with respect to an icon dedicated to the instruction operation, or an operation performed with respect to an existing icon to which a function of the instruction operation has been added.

3. The information processing apparatus according to claim 1, wherein a shape of the photographing view angle of the virtual camera is a radial shape spreading out from a virtual lens of the virtual camera.

4. The information processing apparatus according to claim 1, wherein, in the first display control processing, the photographing view angle of the virtual camera is displayed transparently.

5. The information processing apparatus according to claim 1, wherein the one or more processors and/or circuitry is further configured to execute an exclusion processing that excludes, from the photographing target objects of the virtual camera, an object that has become a target of a predetermined operation, among the objects that are within the photographing view angle of the virtual camera when the photographing view angle of the virtual camera has been displayed.

6. The information processing apparatus according to claim 5, wherein the predetermined operation is a flicking operation or a swiping operation that is performed by a user with respect to the object.

7. The information processing apparatus according to claim 1, wherein the one or more processors and/or circuitry is further configured to
execute a second determination processing that determines whether or not a specifying operation has been performed; and
execute a second display control processing that, in a case of being determined by the second determination processing that the specifying operation has been performed, specifies and displays the photographing target objects of the virtual camera in the XR space.

8. The information processing apparatus according to claim 7, wherein, in the second display control processing, a display of a specific icon around the photographing target object of the virtual camera, a blinking display of the photographing target object of the virtual camera, or a display, in which a border of the photographing target object of the virtual camera is illuminated, is performed.

9. The information processing apparatus according to claim 7, wherein the specifying operation is a single tapping operation, a double tapping operation, or a long press operation that is performed by a user with respect to at least one of the objects that are within the photographing view angle of the virtual camera when the photographing view angle of the virtual camera has been displayed.

10. The information processing apparatus according to claim 7, wherein, in the second display control processing, an object that has become a target of the specifying operation is specified and displayed in the XR space as the photographing target object of the virtual camera.

11. The information processing apparatus according to claim 7, wherein, in the second display control processing, all of the objects that are within the photographing view angle of the virtual camera when the photographing view angle of the virtual camera has been displayed, are specified and displayed in the XR space as the photographing target objects of the virtual camera.

12. The information processing apparatus according to claim 1, wherein the one or more processors and/or circuitry is further configured:
to execute a non-display processing that hides an object that has entered into the photographing view angle of the virtual camera after the photographing view angle of the virtual camera has been displayed, on a live view showing the photographing range of the virtual camera; and
to execute a photographing processing that performs photographing of the live view of the virtual camera.

13. The information processing apparatus according to claim 1, wherein the one or more processors and/or circuitry is further configured to execute a notification processing that notifies a user of an object that has entered into the photographing view angle of the virtual camera, that the object has entered into the photographing view angle of the virtual camera.

14. A control method for an information processing apparatus, the control method comprising:
a determination step of determining whether or not an instruction operation has been performed;
a display control step of, in a case of being determined in the determination step that the instruction operation has been performed, superimposing and displaying a photographing view angle indicating a photographing range of a virtual camera in an XR space; and
a fixation step of fixing objects that are within the photographing view angle of the virtual camera when the photographing view angle of the virtual camera has been displayed as photographing target objects of the virtual camera.

15. A non-transitory computer-readable storage medium storing a program for causing a computer to execute a control method for an information processing apparatus, the control method comprising:
a determination step of determining whether or not an instruction operation has been performed;
a display control step of, in a case of being determined in the determination step that the instruction operation has been performed, superimposing and displaying a photographing view angle indicating a photographing range of a virtual camera in an XR space; and
a fixation step of fixing objects that are within the photographing view angle of the virtual camera when the photographing view angle of the virtual camera has been displayed as photographing target objects of the virtual camera.
